(19) United States
(12) Patent Application Publication
(10) Pub. No.: US 2010/0102126 A1
(43) Pub. Date: Apr. 29, 2010

(54) Container security system

(75) Inventor: Andrew N. Benson, Purdys, NY (US)

Correspondence Address: Andrew Benson, V.P.;Data Security Financial Partners, LLC, Suite 105, 305 Fellowship Road, Mt. Laurel, NJ, 08054, US

(73) Assignee: Data Security Financial Partners, LLC

(21) Appl. No.: 12/586,643

(22) Filed: Sep. 25, 2009

Related U.S. Application Data
(62) Division of application No. 11/292,507, filed on Dec. 2, 2005, now abandoned.
(60) Provisional application No. 60/719,279, filed on Sep. 21, 2005.
(60) Provisional application No. 60/659,312, filed on Mar. 7, 2005.

(51) Int. Cl. G06F 7/08; B65G 11/04; G06K 5/00

(52) U.S. Cl. 235/381; 232/44; 235/380

(57) ABSTRACT

An improved mail depository type container (10), and communication device(s) system for the deposit and aggregation of commodities (100), like paper documents, memory enabled electronic devices and other physical objects, for physical collection and transformation of said objects via shredding or recycling to an unreadable state.

The container (10), similar in design to a Federal Express/UPS drop box, provides a storage area (24) whereby substrates containing sensitive data are stored, a deposit slot (62) where commodities are placed; a user identifier such as credit card reader (54) whereby user information can be electronically communicated (98) to remote locations, a mechanism (80 to 92) triggered by user card, permits delivery to storage area (24), via a locked access door (30). User deposit transaction also authenticated at container by paper receipt (55). The tangible result being the secure storage, collection, and destruction of physical objects; thereby establishing a “cradle to grave” chain of custody accountability verifying the transformation of data from a readable to unreadable state.

### CROSS-REFERENCE TO RELATED APPLICATIONS

This application is a divisional application Ser. No. 11/292,507

### FIELD OF THE INVENTION

The present invention relates to a Container Security System. Such a system is particularly suited for use in preventing the theft of sensitive personal, corporate and government data from external and internal sources by physical or electronic means. The system also comprises improvements to the security of collection and safety receptacles.

### BACKGROUND OF INVENTION

According to many sources, identity theft is or has been ranked as the fastest growing crime in the USA.

With the increasing usage of the Internet, related e-commerce/financial transactions of all forms and more paper documents being utilized to keep hard copies of e-data from the hundreds of millions of printers globally, the social crime of identity theft and fraud is expanding.

This invention solves a problem unique, never before recognized need in the prevention of Identity Theft; namely a Container Security System located in public venues for the aggregation, collection, transport and destruction of sensitive data; the process of which can be managed and monitored via a wired or wireless electronic network, with identifier capabilities and auto reporting formats of transactions.

It is known commercially for carriers such as the United States Postal Service and other, private carriers, to utilize container depositories at local sites for deposit by persons to be delivered to third parties. Relatively low technology mechanical depositories have been developed and are in use that are conveniently located and are secure, and systems for servicing have been developed for retrieval by authorized service personnel of their contents for deliveries to third parties. Representative disclosures are found in: U.S. Pat. No. 6,719,195 B2 wherein a security dropbox has a pivoting service bin that first holds the deposited item when the service door is open and then drops the item when the service door is closed, all providing for secure delivery of items such as mail and packages in a relatively compact space and provides features for protecting delivered items from moisture damage; U.S. Pat. No. 5,526,979 for a security mailbox with outgoing mail pocket in a hinged upper door that otherwise permits deposit of mail that drops past a security wedge into a storage area accessible by means of a locked access door; U.S. Pat. No. 4,363,438 for a mail deposit box with mail-receiving pivotal door chute leading past baffles that deflect mail into an open mailbag on a holding frame that is carried on a horizontal slide accessed through a mail collection door opening; and U.S. Pat. No. 6,742,703 B2 for a mail collection box with upper access slot leading to a chute leading to a bag opening, with the chute and bag moveable relative to each other between a mail deposit mode where they cooperate to form an enclosed pathway to the bag interior, and a mail collection mode where they are spaced apart for removal of the full bag during mail collection via an access door, with an additional feature of a bag-clamping mechanism whereby the bag's top opening may be sealed prior to removal. Another secure deposit box is disclosed in U.S. Pat. No. 6,138,910 which describes a loading door having a telescoping section to support packages being delivered while maintaining security of the storage compartment.

Personal identity theft has become an issue of great concern to almost all people living in developed nations and developing nations. While large businesses and offices have for years been obtaining the services of companies utilizing truck-mounted mobile shredding machines that are able to shred large volumes of sensitive paper documents at a time on site by scheduled visitation or upon call to those business and offices, smaller businesses and firms and also households do not benefit from such a service. Personal shredders have been commercially for many years, but are somewhat costly and must be maintained and emptied, generate some dust from the shredding process, and can present a potential injury risk to families with children.

Such manual shredders are used and maintained in private residential and corporate settings, thus not providing a convenient public alternative fo active, mobile people whose daily work and leisure activities do not afford a convenient private setting.

Commercially available document shredding machines are known having a variety of configurations and designs. For example, in U.S. Pat. No. 3,752,063 is disclosed a document destruction and baling machine. The baling machine has a hinged side with a paper shredding mechanism supported thereon to be movable into closed and open positions to form an openable, cylindrical container for receiving and compressing shredded paper and permitting wires to be wrapped around a compressed bale of such paper and the bale to be removed.

In U.S. Pat. No. 5,261,614 is disclosed a shredding machine utilizing a conveyor belt to transport paper to a feed table of the shredding machine. A mobile paper shredding system is disclosed in U.S. Pat. No. 6,719,226 B2 wherein a paper shredding system is mounted in a truck and is designed and configured to be compact and lightweight, within an enclosure of aluminum and reinforced plastic. Another mobile paper shredder is disclosed in U.S. Pat. No. 5,542,617.

In U.S. Patent Application Publication No. US 2002/0195508 is disclosed a secure disposal system for articles wherein a manually movable wheeled cart receives documents or other articles to be destroyed and has a locked cover. A transfer device automatically unlocks the cover when engaged by the cart, and transfers the enclosure to a position and orientation permitting the cover of the cart to fall open and the articles to drop from the enclosure, into an article destroyer adjacent to the transfer device that then destroys the functionality of the articles.

There has recently come to be known, an apparatus for destruction of containers. In particular, shredding machines have been devised for destroying plastic containers, such as is disclosed in U.S. Pat. Nos. 4,903,126 and 4,784,251, which discloses a reverse vending machine that has a customer door and a shred station, and also a coin supply to refund the customer coins representing the deposit paid at purchase of the container. In U.S. Patent Publication No. 2005/0072870 is disclosed an apparatus for destruction of both paper and plastic containers with separate respective feeders and one common cutting section, and that also may include a HEPA filter for collecting airborne particles; the published application addresses containers having labels that contain sensitive personal information such as medical prescriptions.

### SUMMARY OF THE INVENTION

This invention is a novel Container Security System that addresses the central issue in Identity Theft Prevention; to collect, protect and arrange for the destruction of sensitive personal and corporate information in a secure, monitored and accountable manner; thus preventing such data from falling into the possession of unscrupulous and criminal elements for the purpose of defrauding others.

The inventions utility lay in its capabilities to provide societal elements such as individuals, government and corporations a management tool to facilitate the collection and disposal of their respectively owned and generated sensitive data (and) if so desired have the means to maintain a chain-of-custody/cradle to grave monitoring capability of each item.

Their ability to customize the application of the invention to suit their own objectives is an improvement to much of the prior art noted in collection and safety receptacles.

The invention is commercially successful, presently deployed in select, retail banking institutions for these organizations to provide their customers with a convenient, secure method to protect their personal financial information in the form of printed documents.

The invention is also being commercially used presently in institutional, data operating centers to collect used data tapes and hard drives in a secure manner and aggregated till such time as the institution's collection/destruction agent takes custody at a mutually agreed to time and location.

The present invention is a secure Container Security System that is periodically serviced by authorized personnel to remove the deposited commodities to be further processed such as to be delivered to third parties or to be destroyed such as by being shredded either on-site by mobile shredding trucks or at a remote location.

One feature of the container depository is a self-pay component wherein an individual provides payment such as by credit card and the like, that permits the individual then to deposit a printed document or memory enabled electronic devices, or several such items, to be collected and destroyed so any resident data is no longer legible.

The self-pay component is preferably of the type that communicates with a clearinghouse to denote payment such as by wireless or wired methods for transfer of funds, and preferably the container depository includes a mechanism to issue to the customer a receipt acknowledging payment. With the container depository and method of use system of the present invention, a self-pay, collection depository can accept envelopes for transshipment to third parties, using the components, sensor(s), counters and transmitter(s) of the present inventive depository and the method of use thereof having a management system to direct authorized service vendors.

The self-pay component may be a conventional credit card reader with card insertion slot, or may be a contactless card reader, or may be a cash-receiving component.

The depository is a sturdy, securely locked receptacle defining a commodity receiver and a storage space there within and a locked but operable access door thereto, preferably containing in the storage space a removable and replaceable internal container or bag containing the deposited commodities, that is accessible only by authorized personnel upon use of a keycard, or entry of a code into a multi-button keypad of the access door lock (or both) or the like. Optionally, the customer can place data sensitive items into an envelope provided for that purpose at the receptacle's location such as in a customer-accessible drawer.

The depository can measure the estimated cubic volume and/or weight of the items deposited and can display a pre-programmed dollar amount to be paid by the customer in order to permit deposit of the commodity or commodities by that customer.

The depository's receiver may be a deposit slot with an opening that is of predetermined maximum size and that is in selectable communication with an internal chute, such as by means of a trap-door that is automatable upon both deposit and payment.

A user placement/receiving floor of the receiver can be disposed at an angle downwardly and rearward from the deposit slot to the trap-door, and a sensor may be mounted in the floor of the receiver that can detect deposit into the receiver of a commodity. The trap-door can be activated, through a mechanical linkage, such as by a solenoid that is itself activated by a switch, or by a switch-activated motor, so that upon payment the thus-activated trap-door of the receiver will open and permit dropping of the commodity through the chute and into the storage space, and preferably into an internal container such as a tote or bag, where the deposited commodity remains until removed by the certified personnel for further desired processing. The trap-door can be timed to close after a small, sufficient time period after activation, and optionally can be temporarily blocked until an additional sensor senses complete clearance of the deposited commodity into the chute. Preferably, the trap-door is locked in its closed position by the linkage from being opened inadvertently or even from being forced.

In another embodiment, the depository can be used for the deposit of paper documents and memory enabled electronic device where no payment is relevant.

Within an organization where files, documents, hard drives or data tapes are to be returned to a central office in a secure manner for tracking, such as classified or sensitive documents, the depository can utilize a card reader that reads a passkey card that identifies a person depositing a document into the depository to be later collected or retrieved, along with other similarly deposited documents by other authorized personnel.

The card reader mechanism tracks who made a deposit, and when, and who retrieved deposited documents, and when, thus meeting internal chain of custody requirements such as would be required in government and/or private institutions.

The system of the present invention is directed to a plurality or network of container depositories of the present invention and the managing thereof. Each of the depositories is uniquely identified such as by specific location or by code or both. Each depository includes a wired or wireless transmitter for transmitting information ultimately to a receiver in a depository management system. The information would include the identity of the depository and mark the time of each customer transaction wherein the customer would pay a usage fee and would deposit a commodity to be processed. The container depository management system would ultimately receive the information transmitted and would process the information to gauge traffic through the depository, and would then transmit information electronically to an authorized service/compliance personnel processing office for the particular depository at least to alert the processing office to service the container depository when necessary to remove deposited items. The transmission of information to the authorized commodity processing office could be by wireless transmission or by internet, such as by electronic mail or by website.

The method of doing business of the present invention includes the steps of: providing at least one container depository for use by customers; providing a remote, depository management system and providing communicating to that site from the depository regarding user deposits and transactions, for managing at least one depository and providing communication to that office of information including data concerning each transaction, the volume of commodities and the servicing of the depository; licensing of the at least one depository to a licensee (“authorized service personnel”) who will periodically remove the deposited sensitive commodities for further processing, and optionally signaling the licensee from the depository management site that the depository requires servicing; placing the depository in a particular convenient location for customer usage; and collecting payment from the customers for use of the depository. In one particularly useful embodiment, where the customer is making a payment, the method includes providing a payment clearinghouse remote office site to verify that payment is being made, in order to transfer funds to the depository management office account. The method of doing business may include initially issuing the customer a receipt acknowledging payment and deposit of the commodity, and additionally include later issuing to such a customer, upon the customer's inquiry, a confirmation of the completion of the processing of the deposited commodities (when that action in fact has occurred), such as by means of an internet website where the particular receipt provides the particular customer with the website identification and also a unique confirmation code for use with the website by that customer.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 is an isometric view of the depository of the present invention;

FIG. 2 is an elevational view of the depository of FIG. 1 partially in section to reveal the storage area within, and a document within the storage area;

FIG. 3 is an isometric view similar to FIG. 1 showing by phantom lines, additional detail of interior structure and mechanisms;

FIG. 4 is an enlarged view in section of the top section of the depository of FIGS. 1 to 3 to show the interior mechanisms of the receiver;

FIGS. 5, 5A and 5B are enlarged perspective and elevation views of the actuating mechanism for the barrier door at the interior end of the deposit slot, with FIGS. 5A and 5B showing the open and closed positions of the barrier door;

FIG. 6 is a diagrammatic view of the flow of revenue from the customer to ultimate payees;

FIG. 7 is a diagrammatic view of the flow of transactional data of the present inventive method; and

FIG. 8 is a flow chart of the method of using the depository and the method of doing business of the present invention.

### DETAILED DESCRIPTION OF THE INVENTION

In the drawings, like numerals indicate like elements throughout. In the drawings, like numerals indicate like elements throughout. Certain terminology is used herein for convenience only and is not to be taken as a limitation on the present invention. The term “commodity” includes but is not limited to a document, whether a single sheet of paper or other similar indicia-bearing substrate, or multiple sheets thereof, or multiple such documents, to be deposited for further processing. “Processing of documents” includes but is not limited to: delivery (ultimately) to a third party designated by a customer; and assured document destruction such as by shredding. The acronym “NAID” represents National Association of Information Destruction. The terminology includes the words specifically mentioned, derivatives thereof and words of similar import. The embodiments illustrated below are not intended to be exhaustive or to limit the invention to the precise form disclosed. These embodiments are chosen and described to best explain the principle of the invention and its application and practical use and to enable others skilled in the art to best utilize the invention.

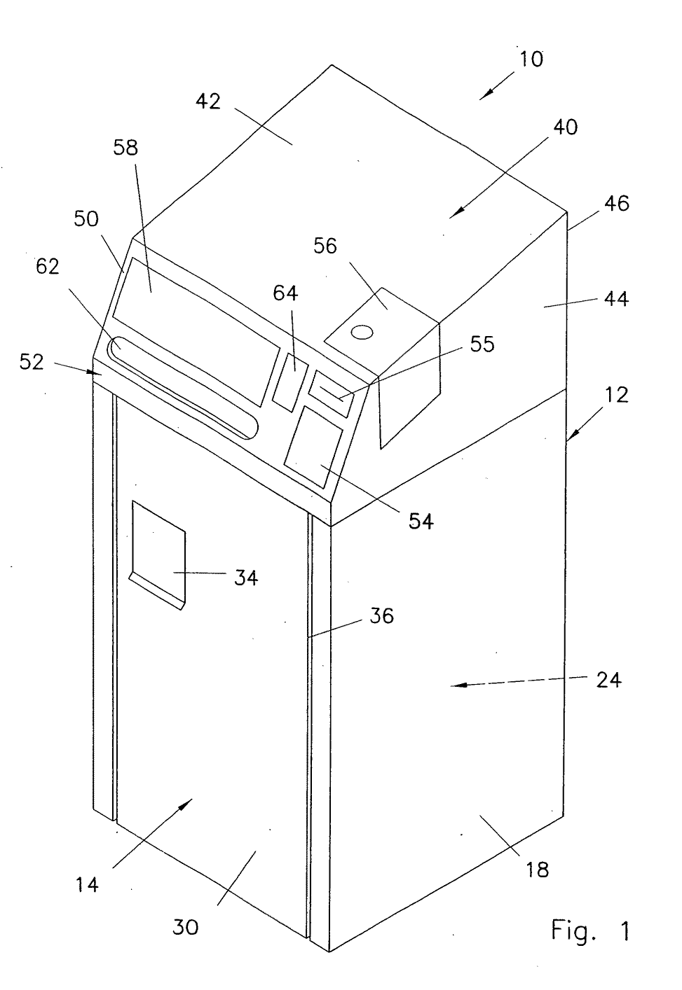

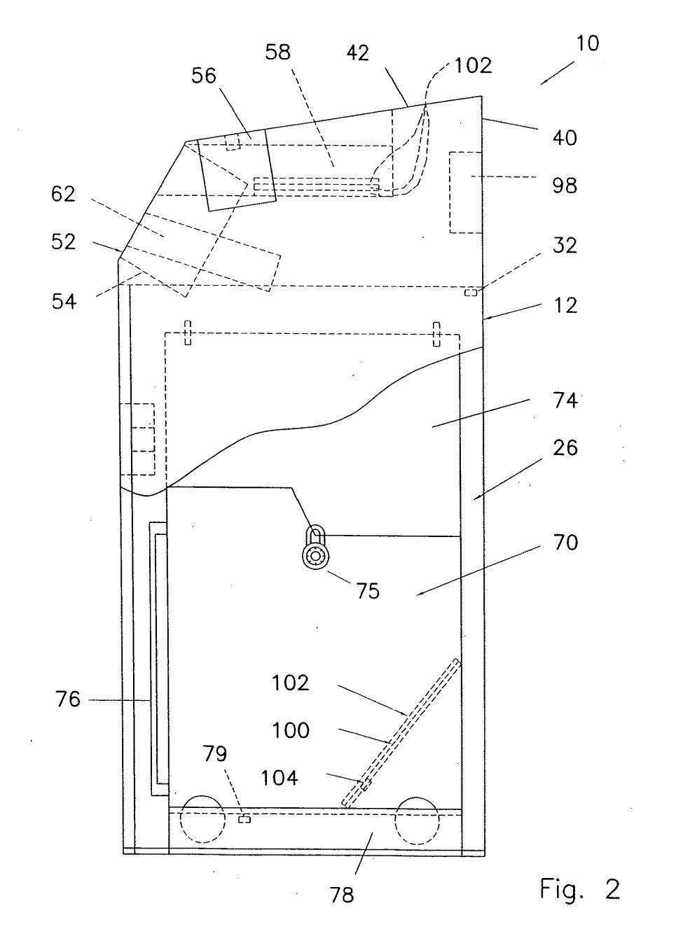

An embodiment of the depository of the present invention is illustrated in FIG. 1. A depository 10 has a secure enclosure 12 with a front face 14, a bottom wall, opposed side walls 18, a rear wall and a top section 40, all defining therewithin an interior space including at least a storage area 24. A secure, locked, openable access door 30 is defined within, or comprises, one of the walls of the secure enclosure 12, and is shown in FIG. 1 as being disposed in the front face 14 thereof. The walls and bottom and top of the enclosure 12 are of known, sturdy, damage- and vandal-resistant materials and construction. Preferably, depository 10 would be mounted securely in position, such as in the vestibule of a grocery store, by being securely fastened to the vestibule floor or in other conventional ways. It would be preferable to incorporate into the depository an RFID (radio frequency identification device) 32 (see FIG. 2) or microchip to enable tracking of the depository by a depository management office in the event of theft of the depository from its designated site.

Door 30 includes a lock 34 to be opened only by authorized service personnel thus permitting access to the storage area. Lock 34 may preferably comprise a concealed pushbutton keypad combination lock that is openable upon entry of the proper code by the authorized service personnel, whereafter access door 30 is openable such as by hinged pivoting about a side edge 36. Other locks may be used, however, as are known to the skilled artisan. Optionally, a key card reader lock system may be used that activates the keypad combination lock, or may itself unlock the access door.

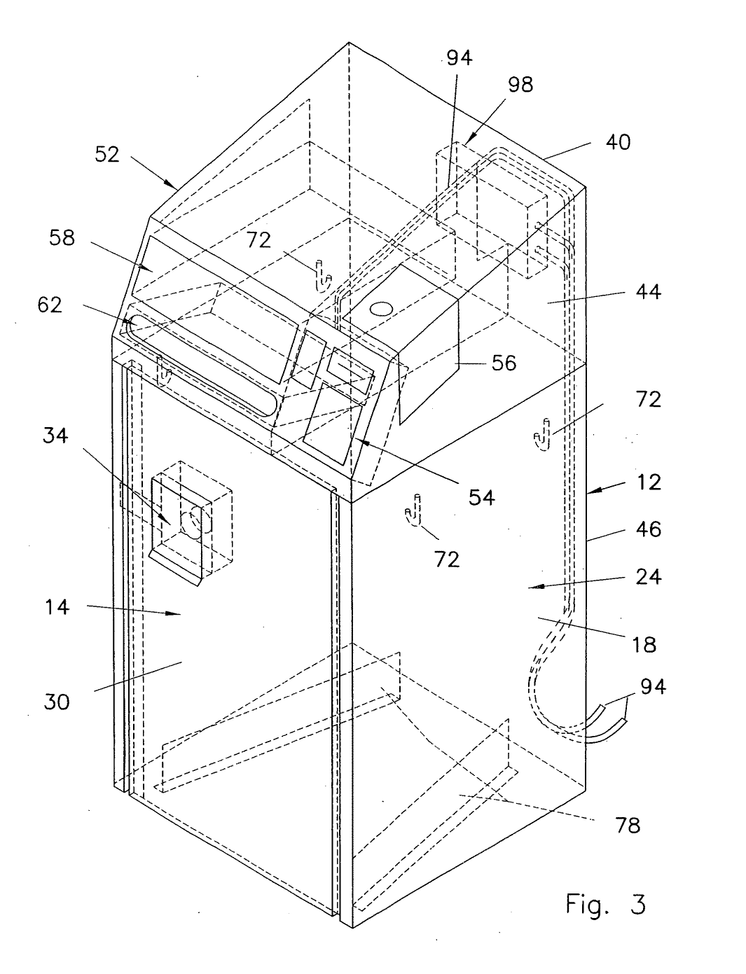

Referring now to FIG. 3 in particular, top section 40 includes a top wall 42, side 44 and rear 46 walls, and a forward face 50. Top wall 42 may be used as a work surface by the customer. The top section 40 includes operable portions including a receiver 52, and a credit card reader 54 (or, optionally or additionally, a cash insert mechanism) preferably with a printer (with a paper roll insertable into an aligned position situated within a printer access door 56) for printing a receipt or acknowledgement of deposit that would issue forth through a receipt pickup slot 55; the credit card reader may be of the card-insertion type or may be a contactless reader as has recently become commercially available. Preferably, a barrier wall 96 is disposed beneath the printer access door 56 to prevent improper access to the storage area 24 when the printer access door is opened. The card reader 54 would necessarily have a wireless (or wired) transmitter 98 to a financial clearinghouse to signal the transfer of funds from a customer account to a depository office account, and may have the capability of simultaneously signaling the depository remote site office of a transaction.

Top section 40 is shown to also include a supplies access door 58 within which may be stored envelopes within which a customer may place the commodity to be deposited. Such envelopes 102 (see FIG. 2) could incorporate integrally therein an RFID 104, or microchip or the like for wireless tracking, if such tracking is so desired by the customer. Preferably, card reader 54 also will read identification passkeys of authorized service personnel. Or, optionally, receiver 52 also includes a separate, additional card-reader (not shown) for use by authorized service personnel using an authorized identification passkey. Either arrangement enables servicing activity to be documented not only as to time but also as to the identity of the particular authorized service personnel removing the contents of the storage area or performing other servicing activity, and this servicing information would be transmitted to a clearinghouse and be retransmitted to a management depository office. Also seen in FIG. 1 are deposit slot 62 and message display panel 64, which may be separate from the card reader mechanism as shown, or may be an integral part of a card reader assembly as is commercially available.

As shown in FIG. 2, the interior of the depository 10 of FIG. 1 includes a storage area 24. Within the storage area preferably is an open-top container 70 that would receive dropped thereinto the commodity deposited by a customer, with container 70 being removable by authorized service personnel upon opening of access door 30. Container 70 may be a canvas bag (not shown) that hangs from hooks 72 mounted within the enclosure such as at the corners near the top of the storage area and have a drawstring for closure during transport such as by a hand truck. The container 70 may be a wheeled tote bin preferably with a closable lid 74 and a handle 76 as shown in FIG. 2 to facilitate removal from the storage area and transport to a remote facility for further desired processing, by the service personnel; guides 78 are shown in the floor of the depository to guide the wheels of the tote bin to a centered location within the storage area. Whether the container 70 is a tote bin or a canvas bag or the like, consistent with the important principle of security, a lock such as lock 75 is provided on the container that is locked for transport of the commodities by the authorized service personnel; such lockable tote bins are known such as are used by the Transportation Security Department on movable confiscation bins. Optionally, container 70 could include a sensor (not shown) for measuring the weight of commodities received thereinto and a transmitter (also not shown) such as an RFID 79 or microchip, for purposes of tracking thereof by a depository management office.

When the depositories of the present invention are utilized for assured document destruction, the authorized service office may be a local document destruction company, and the documents could be wheeled to a mobile shredding machine such as on a truck, or could be trucked to a remote shredding facility; in either case, the shredded documents could be taken to a recycling facility.

Authorized service personnel would preferably comprise employees of a local document processing company that operates one or more trucks, and who service the depositories for resupplying document envelopes and correcting box malfunctions in the drawer open/close mechanism or point-of-sale terminal, and/or telephone number for in-store employees. Such an authorized service person would have for example a passkey card (described above) that would be readable by the receiver, and who would be provided with the appropriate code to use with the coded access lock 34 to unlock access door 30, enabling the personnel to remove the container 60 and replace it with an empty, like container 70, whereafter the depository is again operable to permit customer transactions.

Above storage area 24, the depository's receiver 52 has a deposit slot 62 of predetermined maximum size that is in communication with a commodity-bearing floor 80 that in turn is in communication with storage area 24 such as by means of a barrier such as an actuating door (or “trapdoor”) 82 that is activatable upon both deposit and payment to be moved out of its chute-blocking rest position. Commodity-receiving floor 80 of the receiver preferably is disposed at an angle downwardly and rearwardly from the deposit slot to the trap-door 82, and a paper sensing microswitch 84 may be mounted in the floor of the receiver that can detect deposit into the receiver of a commodity.

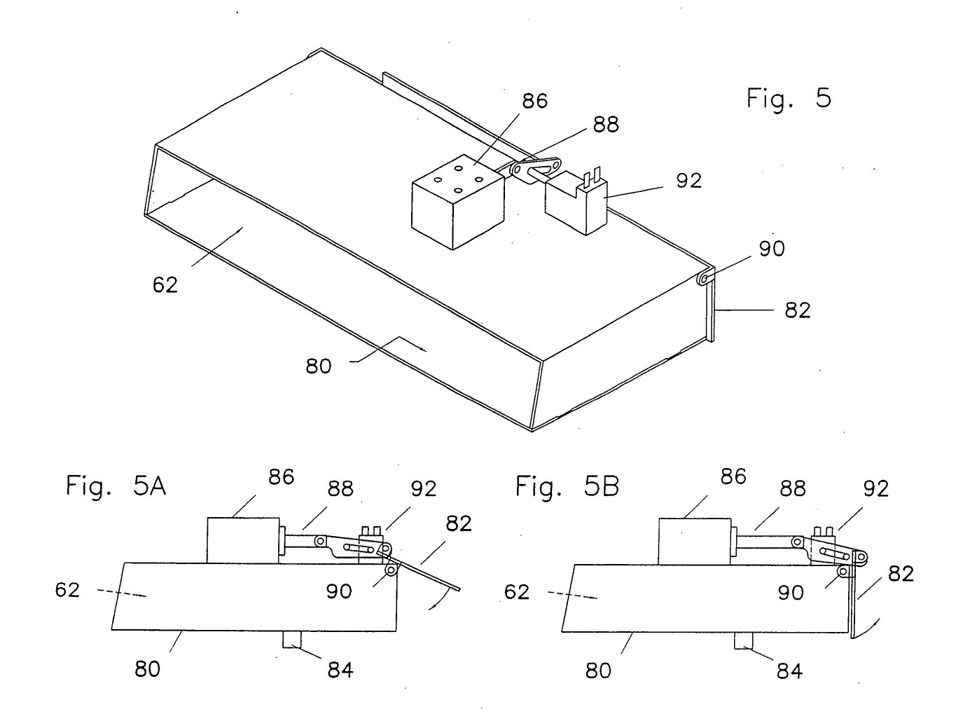

Referring more particularly now to FIGS. 5, 5A and 5B, the trap-door 82 is hingedly attached at pivot 90 to deposit slot 62 can be moved such as by a solenoid 86 and linkage 88, or a motor (not shown), when activated by a switch within the card reader confirming payment and when the commodity is sensed by microswitch 84, so that upon payment and deposit of the commodity the thus-activated trap-door of the receiver will be moved from its blocking position and permit dropping of the commodity into the storage space. Solenoid 86 in turn activates linkage 88 that moving about several fixed pivots (depicted by arrows in FIG. 5A) will cause trap-door 82 to be rotated about its pivot hinge 90 whereby it is assembled to the top rear of the deposit slot 62, closing off and blocking the opening to the storage area when held in its closed position (FIG. 5B) and clearing the opening when held in its open position (FIG. 5A). Also shown in FIGS. 5, 5A and 5B is an additional solenoid 92 with a sensor that detects when a deposited commodity clears the opening and enters the storage area 24, whereafter it permits solenoid 86 to move linkage 88 to close the trap-door 82 to its blocking position. Closing of the trap-door also can be controlled by a timing mechanism that allows 200 milliseconds in its open position and activates the solenoid to close the door and can be used in conjunction with solenoid 92 once the clearance sensor determines that the deposited commodity has cleared the opening.

Preferably, the ceiling of the receiver would be of greater height than the deposit slot 62 to allow for expansion of the deposited documents after insertion through the slot. Optionally, the receiver's floor could initially be level and could pivot about a front hinge to lower the floor to a declining orientation sufficient to drop the commodity into the storage area, whereafter a switch-activated spring could again raise the floor to a level orientation.

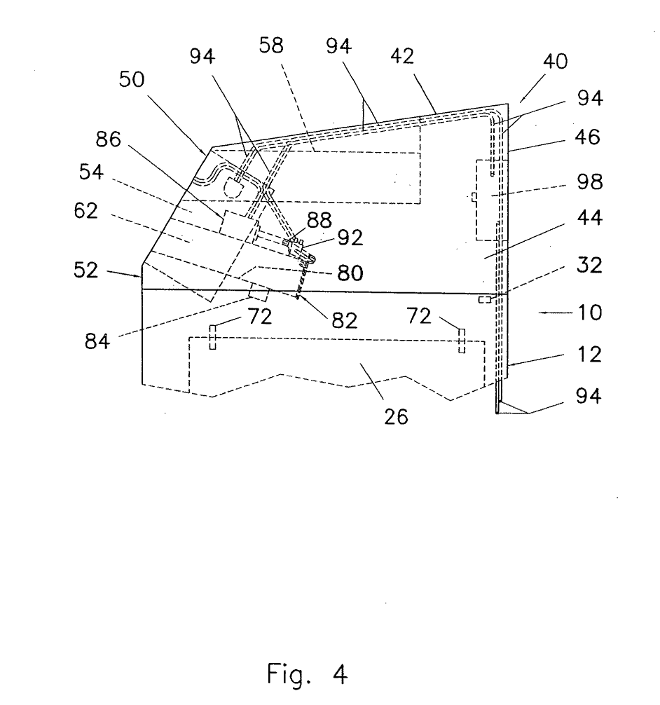

Preferably, depository 10 includes a wireless controller with transmitter 98 that communicates directly with a financial clearinghouse and ultimately a remote site depository management office, information generated by a customer transaction, with the clearinghouse arranging the transfer of funds from the customer's account to an escrow account for the management depository office. Power and wired signal transmission can be provided by electrical/fiber optic cables as shown. Cabling 94 (FIGS. 3 and 4) extends from the cable entrances shown adjacent the bottom of the rear wall 46, extend upward to the transmitter 98, then upward to the inside of the top wall 42, then forwardly to card reader 54 for at least providing power to the transmitter, the card reader and the solenoids, and signal cabling at least between the card reader and the transmitter and that is shown extending exteriorly of the depository in FIG. 3.

Alternatively, the depository may include a weighing mechanism or sensor (not shown). In this embodiment, when customer deposits the commodity into the deposit slot, the weight of the deposited commodity is measured or sensed in order to calculate the amount to be paid by the customer, which amount would be displayed on message display panel 64 for informing the customer of the amount to be paid. The customer would then make payment, such as by cash or credit card or the like. Upon assurance of payment of the calculated amount owed, the chute would be released to permit the deposited commodity to drop into the storage area.

Mechanisms for weighing documents and calculating a fee are commercially known. For example, such mechanisms are manufactured by Pitney Bowes for weighing letters and determining appropriate postage for placing the letters into the USPS mail delivery system, such as Product No. DM200i/DM300i Digital Mailing System.

Apparatus for secure cashless payment is commercially known. One particular example of a mechanism for cashless payment is available from USA Technologies, as G4 e-Port.RTM. apparatus that is scalable and is installable into a machine such as an automated teller machine (ATM) or vending machine, that has audit capabilities enabling viewing of transaction level detail by machine online, and that may have a cardreader interface or a currency-acceptor interface, and also either a networking interface such as wireless modem, GSM, POTS modem—analog, and Ethernet, and also an MDB interface or DEX interface, and optionally includes a receipt printer.

The depository 10 optionally could also include a sensor (not shown) to detect when the storage area requires being emptied. The sensor would be operably connected to a preferably wireless transmitter that then sends a wireless signal to the office of the authorized service personnel, or another site that will communicate the information to the authorized service personnel. Optionally, such information could be transmitted by the wireless transmitter of the card reader 54 to the financial clearinghouse to be retransmitted to the depository management office at the time of each customer transaction, and would also transmit the unique identification code for the particular receiver. The receiver would preferably display to a potential customer, on message display panel 64, a message that the depository is full and presently out of service until emptied. Such measuring capability would compare either the number of transactions simply by counting each payment, or the weight of deposited commodities or volume of deposited commodities against a preselected maximum for the particular depository. Preferably, a passkey may be swiped in card reader 54 (or another card reader) by the authorized service personnel, to “zero” the sensor, signifying that the storage area is now empty and the depositor is again available for customer use.

The depository of the present invention could also signal, either directly or via financial clearinghouse to the depository management office and ultimately to authorized service personnel of the need for maintenance to the depository other than emptying when a fault sensor detects jamming, or significant impact from a foreign object, or fire, or removal of the depository from its base, or some disruption of the access door or other wall or floor of the depository. Alternatively, an alarm (not shown) on the depository activated by such a fault sensor could alert in-store employees of such malfunction in or damage to the depository at their site, who then could notify the authorized service personnel such as by telephone or internet.

Other options for the depository of the present invention include a second work surface on one or both side walls of the depository if space permits at the site where the depository is positioned. A vertical message display board may be mounted above the rear of the receiver and have an LCD, or a pop-up display, used in conjunction with a motion sensor. The depository may include a speaker to announce audio messages to a customer, such as “Please do not forget your receipt” and so forth.

The depository of the present invention may be installed in a variety of types of public locations, preferably indoor, such as in vestibules of banks, post offices, apartment buildings, grocery stores, office supply stores, shopping malls, business and professional office centers, shipping/copying/printing establishments, transportation hubs, geographically remote locations and the like.

In another embodiment, the depository can be used for secure depositing of documents (or commodities) where only identification, not payment, is relevant. Within an organization where files or documents or commodities are to be returned to a central office in a secure manner for tracking, such as classified or sensitive documents, the depository can utilize a card reader that reads a passkey card that identifies a person depositing a document into the depository to be later collected or retrieved, along with other similarly deposited documents by other authorized personnel. In this embodiment, the commodities could be, in addition to documents and paper files, CDs, hard drives, disks and all other data recordation/storage instruments, whether paper, electronic or other media. The card reader mechanism tracks who made a deposit, and when, and who retrieved deposited documents, and when, thus meeting internal chain of custody requirements such as would be required in government and/or private institutions. In such a use, the depositories would not necessarily be located in public-accessible locations but instead within offices and buildings such as are provided with security systems. Similarly to the previously described embodiments, wired or wireless transmissions may be made to a central management system with similar advantages as are described hereinabove and hereinbelow, using a card reader mechanism for personal identification, but not for payment, purposes.

Advantages of the depository of the present invention are that it minimizes handling of commodities, and thus minimize the risk of loss or theft, until they are assuredly processed. Such a depository of the present invention can be located locally to residences in local businesses and offices for the convenience of households and small firms and offices. Such a depository is also space-friendly, with minimal moving parts, thus requiring little maintenance. When the depositories are utilized for assured and secure document destruction, shredded documents may easily be recycled through the use of established document destruction businesses that also service the depositories of the present invention; such a process reduces reliance on personal shredders.

The present invention includes also a system for managing a plurality of the depositories of the present invention. Each depository would have a unique identification code and would transmit that code when transmitting each customer transaction, as well as the time of the transaction. The depository management office would receive each such transmission and process the information received, including notifying the particular authorized commodity processing office for that depository of the need to remove commodities therefrom when necessary, which may be by wireless transmission or by a website or by interne communication. Further, the depository management office would process all such information received from the depositories, such as to analyze traffic to identify the need for other new depositories in certain vicinities.

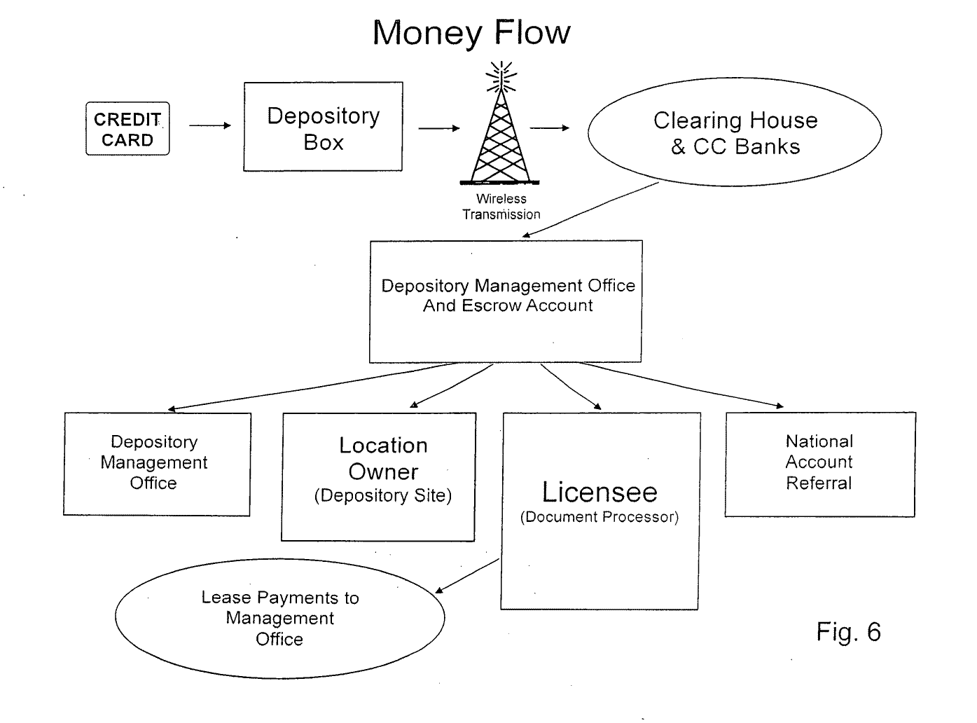

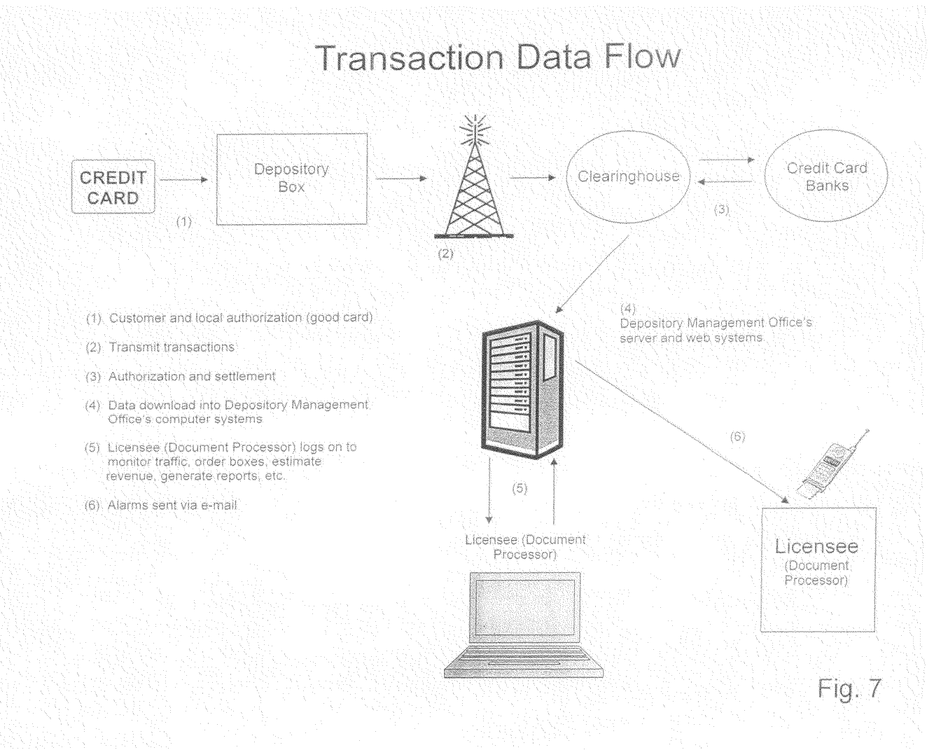

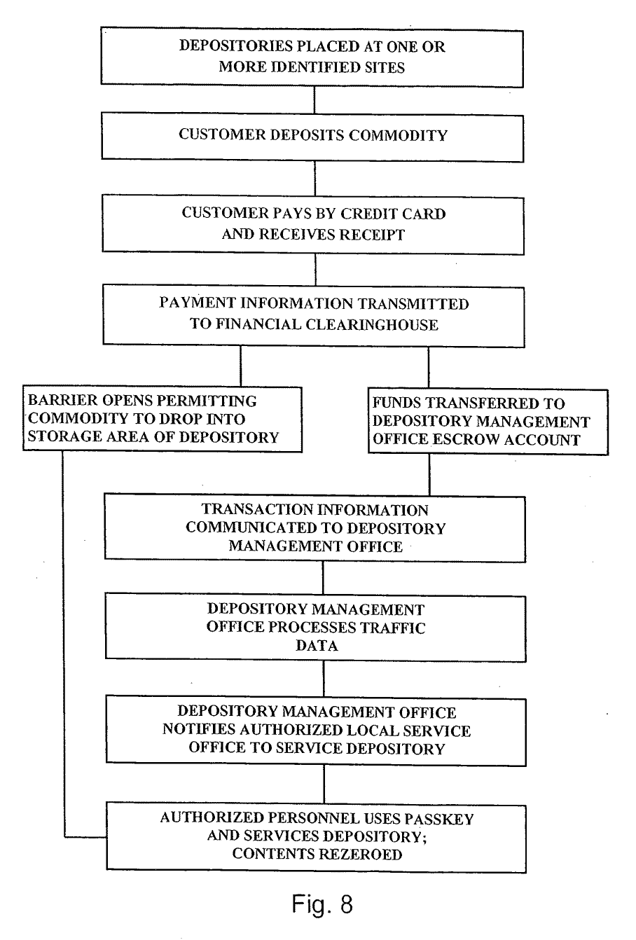

The method of use and of doing business of the present invention, is diagrammatically illustrated in FIGS. 6 to 8. FIG. 6 is a diagrammatic view of the flow of revenue from the customer to ultimate payees; FIG. 7 illustrates the flow of transactional information from the depository to the depository management office; and FIG. 8 is a flow chart of the method of using the depository and the method of doing business of the present invention.

In these Figures is shown a financial clearinghouse at a remote site receives credit card use transmissions from at least one depository in order to notify respective ones of several credit card banks to transfer funds from particular customers conducting transactions at the depository or depositories, into an account for a depository management office, also at a remote site. The remote depository management office site can track each customer access, or servicing, of a particular depository in a system of depositories in various locations, by wireless or interne communication either directly from the depository or depositories or indirectly via retransmission from the financial clearinghouse.

The depository management office can in turn notify authorized local document processing offices of the need to service a particular depository, or of the occurrence of service activity related thereto and by whom. The depository management office can automatically and contemporaneously track the transactions of each of the depositories in the system, which can not only provide the data base for notification of document processing offices in respective areas but also to determine the potential value of additional depositories in certain areas or even establish communication with the local establishment whereat particular depositories are located such as for financial information or payment transfer to the local establishment if on a per-use basis, as is illustrated in FIG. 6 which demonstrates the flow of revenue from the customer ultimately to the depository management office and then to one or more other payees including: the Licensees who are the authorized service and commodity processing offices; the owners of the depository sites; and possibly referral fees to national accounts. Also shown are payments by the depository lessees to the depository management office for leasing the depositories.

There may also be a multilevel signaling system wherein a preliminary signal from the depository management office to the licensee document processing, can communicate that the storage area of a particular identified depository is “70%” full, then “92%” full, and then completely full, requiring immediate servicing. Another feature of the present invention could be that the thresholds and maximums for the storage area can be adjustable from the depository management office, based on traffic or on other criteria. Additional technology features to allow for customized applications could include touch screen/LCD panels to improve customer interactivity, a GPS tracking device in the event of depository theft, or even a GPS tracking device built into the container for tracking after removal from the depository. Where the document processing desired by a customer at an appropriate depository is document destruction, the method can also include the step of destroying the deposited commodities by a mechanism within the depository itself, such as a small shredder, and then periodically removing the shredding debris by authorized personnel.

It is also within the scope of the present invention, to provide a method of notifying a particular customer of a depository with a Certificate of Document Processing, e.g., document delivery to a third party, or document destruction. In particular, a depository can print on the customer's receipt a Confirmation Number and a website address; later, that customer can visit the website, using the Confirmation Number, to obtain a Certificate of Document Processing that would be available for issue as soon as the contents of the depository have been in fact been, respectively, delivered by the carrier, or destroyed by the NAID certified document destruction business responsible for the particular depository used by that customer.

Further, the method of doing business can enable making traffic and payment data available, such as by website of the depository management office or licensor, to licensees such as document carriers or document destruction businesses, to service identified depositories promptly, and to order and allocate additional depositories, estimate revenue and generate reports, in return for license fees.

It is specifically foreseeable that with the depository and method of use of the present invention, a self-pay, collection depository can accept envelopes for transshipment to third parties, using the components, sensors and transmitters of the present depository and the method of use thereof having a depository management system and authorized carrier service offices.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A Container Security System method for the collection and custody management of printed paper(s) and electronic, memory enabled devices containing sensitive data intended for destruction to an illegible and/or unusable form;
a) providing one or more secure container depositories into which a user(s) can deposit paper documents and electronic, memory enabled devices that contain data;
b) an onsite and/or remote office management system that monitors usage/user activity in one container or a plurality of containers;
c) providing in each container depository a user transaction identifier mechanism for a user conducting a physical transaction at a container depository;
d) dispensing from each container depository a paper printed, physical receipt to said user acknowledging/confirming the deposit being made by said user;
e) providing in each container depository a secure storage location for said data sensitive items to reside until collection;
f) providing a sensor/counter mechanism in each container depository to measure aggregated volume levels into said secure storage area to ascertain a need for removal of said items;
g) providing a wired or wireless communication transmission feature in communication with said sensor/counter to notify said onsite/offsite management system resident items aggregated in storage area to be collected by authorized service personnel and destroyed;
h) providing a secure locked access door in each container depository to be accessed by authorized service personnel to remove resident items from said storage area for destruction and recycling.

2. The step (c) of claim 1, wherein the user transaction identifier method is a credit card, employee card, smart card, touch pad, RFID, or biometric identifying method and communicated to the management system office for processing payment or other designation.

3. The step (b) of claim 1, whereby the office management system electronically collects user/usage activity via land based phone network cables, cell phone networks, the Internet and/or satellite based networks.

4. The step (d) of claim 1, provides users/users organization with a unique, per user transaction numbering sequence common to the printed receipt and to a digital transmission receipt of a particular user transaction; thus providing an electronic retrieval capability via the Internet or Intranet networks for user to confirm destruction of their sensitive data.

5. The step (d) of claim 1, providing user(s) accessing and using a container depository in a public venue the capability to retrieve via a website confirming information that the data materials deposited into the container depository have in fact been destroyed, aka ‘Certificate of Destruction’

6. The step (d) of claim 1, providing users organization a chronology of usage activity by employees authorized to access container depository to establish chains-of-custody thereby mitigating the risk of data breaches.

7. The step (f) of claim 1, providing for daily, automated emails to authorized collection and destruction service vendors that days aggregated volume in the storage area of each container depository; thus advising service vendor to securely remove items from the container depository and destroy.

8. A Container Security System whereby a chain-of-custody of deposited materials/substrates handled by multiple people is established, from user-to-collector-to destruction agent-to recycler.

9. A Container Security System where user deposit transaction identifiers can be customized to a particular application by an organization to insure compliance with legal mandates.

10. A Container Security System whereby compliance with select environmental shipment and disposal laws can be confirmed by monitoring chain-of-custody activities; such as the shipment of toxic materials present in electronic devices being shipped to developing countries for disassembly by under age children in a manner detrimental to their health.

11. A Container Security System of claim 1, wherein the container incorporates therein an RFID enabling tracking of the container (and/or contents upon and after removal from the container.

12. A Container Security System Depository comprising a removable container is disposed within the storage area to receive materials/substrates deposited into the container.

13. The Container Security System Depository, wherein the container is closeable upon removal from the storage area and includes a lock to maintain security of the contained commodities during handling and transport of the container contents for destruction.

14. The Container Security System Depository, wherein the depository includes a commodity-receiving slot, a commodity-bearing floor sloping downwardly and rearward to a barrier initially in a blocking position, the activating mechanism activating the barrier upon customer payment to temporarily remove the barrier, thus permitting the commodity within the commodity-receiving slot to drop into the storage area, and the activating mechanism returning the barrier to a blocking position.

15. The Container Security System Depository, wherein the activating mechanism includes a solenoid activated by first and second switches, the first switch detecting that payment has been made, and the second switch detecting that a commodity has been placed into the commodity-receiving slot.

16. The Container Security System Depository, wherein a timer signals the solenoid to activate the barrier to return it to its blocking position after a preselected, limited amount of time.

17. The Container Security System Depository, wherein a clearance sensor detects when the commodity being deposited has cleared the commodity-receiving slot past the barrier location, and signals the solenoid to remain passive in returning the barrier to its blocking position until clearance has occurred.

18. The Container Security System Depository, wherein the activating mechanism further includes a linkage between the solenoid and the barrier that moves the barrier between its blocking and open positions.

19. The Container Security System Depository, wherein the linkage is adapted to lock the barrier in its closed position to prevent unauthorized or forced opening thereof, consistent with protecting the security of already-deposited commodities within the storage area.

20. The Container Security System Depository, wherein the second switch is a sensor within the commodity-receiving slot that senses the presence of a commodity being deposited.

21. The Container Security System Depository, wherein the depository includes a transmitter that signals a remote site that usage activity has occurred or payment has been made by a customer to deposit a commodity.

22. A plurality/network connected Container Security System of multiple depositories, and further including an authorized service office adapted to receive information from the transmitter for processing thereof to arrange for removal and further processing of the commodities within the storage area.

23. The Container Security System Depository of claim 1, further including a transmitter for transmitting information about each transaction to a remote site to be processed.

25. The Container Security System Depository, wherein the pay-to-deposit mechanism is a card reader at least adapted to read a credit card or the like appropriately used by a user/customer, for the transmitter to transmit information to a remote, pre-designated clearinghouse.

26. A plurality/network of depositories, and further including a Container Security System management system adapted to at least ultimately receive transaction information from the transmitter for processing thereof.

27. A Container Security System for receiving commodities from customers at a plurality of sites for secure processing, comprising: a plurality of secure depositories as set forth in claim 1 respectively having at least one transmitter; a remote site having a receiver for receiving information transmitted by the transmitters of the plurality of depositories; a management system for ultimately receiving information transmitted by the transmitters and for processing information so received and also having transmitters to transmit either certain of the information so received, or certain information formulated from processing the information so received; and one or more authorized commodity processing offices having receivers for receiving information transmitted from the Container management system for authorized personnel to service one or more of the depositories and securely process the commodities.
